(19) United States
(12) Patent Application Publication
(10) Pub. No.: US 2009/0219515 A1
(43) Pub. Date: Sep. 3, 2009

(54) Interferometic Measuring Device

(76) Inventors: Hartmut Spennemann, Aschaffenburg (DE); Bernd Schmidtke, Gerlingen (DE); Ulrich Kallmann, Tuebingen (DE); Sebastian Jackisch, Ludwigsburg (DE)

Correspondence Address: KENYON & KENYON LLP, ONE BROADWAY, NEW YORK, NY, 10004, US

(21) Appl. No.: 11/991,921

(22) PCT Filed: Sep. 4, 2006
(86) PCT No.: PCT/EP2006/065956

§ 371 Date: Mar. 6, 2009

(30) Foreign Application Priority Data
Sep. 22, 2005 (DE) 10 2005 045 513.1
Apr. 6, 2006 (DE) 10 2006 016 131.9

(51) Int. Cl. G01N 21/00

(52) U.S. Cl. 356/73

(57) ABSTRACT

An interferometric measuring device for measuring layer structure of a plurality of layers has: a scanning apparatus for displacing an interference plane relative to the layer structure; an interferometer part having a wavelength scanning interferometer; an image recorder recording the interfering radiation returning from a reference arm on an object arm, and producing electrical signals as output; and a downstream evaluation device for making available the measuring results.

### BACKGROUND OF THE INVENTION

1. Field of the Invention

The present invention relates to an interferometric measuring device and method for measuring layer structures of a plurality of layers.

2. Description of Related Art

An interferometric measuring device for measuring layer structures of a plurality of layers lying one behind another in the depth direction has a scanning apparatus, which scans them automatically in its depth direction, using which an interference plane is displaceable relative to the layer structure, and also has a white light interferometer and/or an interferometer part, having a wavelength scanning interferometer, to which an input radiation is supplied, for the measurement, by an irradiation unit, which is split using a beam splitter and supplied, in one part, to a reference arm via a reference ray path as a reference beam, and in the other part, is supplied via an object beam path as object beam to an object arm which has the layer structure during the measurement, and also has an image recorder which records the interfering radiation returning from the reference arm and the object arm and converts it into electrical signals, as well as having a downstream evaluation device for making available the measuring results.

Such an interferometric measuring device is shown in published German patent document DE 101 31 779. In this known interferometric measuring device, which operates according to the measuring principle of so-called white light interferometry, a surface structure of a measuring object is scanned in the depth direction (z direction), using a scanning apparatus, in that the length of a reference light path is changed relative to the length of an object light path, so that the interference plane, which is defined by the cooperation of a reference beam guided through a reference arm and an object beam guided through an object arm, is displaced relative to the object surface. One specialty of this known interferometric measuring device is that several surface areas of the measuring object are able to be recorded and scanned at the same time, for which a special optical system, namely, a so-called superposition optical system or an optical system having a sufficiently great depth of focus, or a multifocal optical system, is situated in the object arm, using which the various surface areas are able to be recorded at the same time. As a result, correspondingly different beam paths come about in the object arm for the various surface areas to be measured, so that the surface areas are then measured while making relative changes in the optical length of the object light path to the optical length of the reference light path, for instance, by adjusting a reference mirror in the depth scanning direction, with respect to its topographical surface structure. This design is especially suitable for scanning of laterally adjacent surface areas, which may have different orientations or may be offset in the depth direction. A parallelism or a thickness of the various surfaces are also able to be measured. In this context, the surfaces that are spatially separated from one another are constantly recorded at the same time, so that an adjustment of the optics in the object arm has to be provided that takes into consideration the relative positional relationship of the two surfaces that are to be measured.

In an interferometric measuring device shown in published German patent document DE 197 21 843, various surface areas of an object, particularly even in tight bores, are also able to be measured using a partly common object arm, object beam paths associated with the various surface areas being likewise formed. In this instance, the measured surface areas are separated from one another, so that, for example, the roundness of a cylinder bore may be checked. The various surface areas are distinguished based on different polarization directions of the associated object beams. In this case, too, the imaging of the various surface areas takes place simultaneously via the object arm.

One additional interferometric measuring device shown in published international patent document WO 01/38820, which is also based on white light interferometry, is constructed so that, using it, thickness measurement, distance measurement and/or profile measurement, may also be undertaken on layers lying one behind another, as, for instance, in opthalmological measurement, the thickness of the cornea, the depth of the anterior chamber, the thickness of the retina layer or the retina surface profile. Various light paths are also developed for this in the object arm, which are assigned to various layers and boundary areas, in order to achieve as rapid as possible a measurement. The object beams (measuring beams) have different optical properties for distinguishing and assigning the various measured surfaces and boundary areas, such as a different polarization direction or a different wavelength; a change in the detour of the various object light paths in the object arm is also possible, but it leads to a loss in sensitivity, which is referred to in this document.

More basic discussions on white light interferometry may be found in T. Dresel, G. Hausler, H. Venzke, “Three-dimensional sensing of rough surfaces by coherence radar”, Applied Optics Vol. 31, 919 (1992), as well as in P. de Groot and L. Deck, Journal of Modern Optics, “Surface profiling by analysis of white light interferograms in the spatial frequency domain”, Journal of Modern Optics, Vol. 42, 389-501 (1995). In Kieran G. Larkin, “Efficient Nonlinear Algorithm for Envelope Detection in White Light Interferometry,” J. Opt. Soc. Am. A, (4):832-843, 1996, it is stated how, using a special algorithm, the modulation M of a correlation curve is able to be determined from recorded intensity values, according to the so-called FSA method (five-sample adaptive method). Another procedure for identifying and evaluating a correlation curve is by observing the interference contrast.

An object of the present invention is to provide an interferometric measuring device and a method for measuring layer structures which give(s) measuring results that are as reliable as possible at as low as possible an expenditure.

### A BRIEF SUMMARY OF THE INVENTION

In the device according to the present invention, it is provided that the scanning device is developed in such a way that, at a constant reference beam path and object beam path, the associated scanning path is developed to be at least as great as the distance, that is to be expected or has been ascertained in a pre-measurement, between at least two boundary areas of the layer structure that are to be recorded, situated one behind the other, if necessary, with the addition of a depth structure of the boundary areas that is to be expected; and in the case of the development of the interferometer part having the irradiation unit as a white light interferometer, the coherence length of the input radiation is selected to be at most so great that the interference maxima of the correlation curves occurring one after another during the depth scanning are able to be distinguished at the boundary areas that are to be recorded, and/or in the case of the development of the interferometer part having the irradiation unit as wavelength-scanning interferometer, the irradiation unit is developed to have narrowband, tunable input radiation, the bandwidth of the input radiation being selected to be so big that the smallest distance apart, of the boundary areas lying one behind the another that are to be recorded, to be expected or to be estimated by the pre-measurement, is resolvable, and/or in the case of the development of the interferometer part as a wavelength-scanning interferometer having a spectrally broadband irradiation unit and a wavelength-scanning optical spectrum analyzer as detector, the bandwidth of the input radiation is selected to be so great that the smallest distance apart of the boundary areas lying one behind another that are to be recorded, that is to be expected or that is to be estimated by pre-measurement, is resolvable.

The method provides that in the depth scanning of all the layers that are to be measured, and the boundary areas that border on them, in one scanning cycle, the object beam is guided over the same object beam path and the reference beam is guided over the same reference beam path, and in the application of the method of white light interferometry, the coherence length of the input radiation that is coupled into the interferometer is selected to be at most so great that the interference maxima of the correlation curves that occur one after another, during the depth scanning, at the boundary areas that are to be recorded, are distinguished, and in the application of the method of wavelength-scanning interferometry, the bandwidth of the input radiation is selected to be so great that the smallest distance apart of the boundary areas to be recorded, that is to be expected or estimated by pre-measurement, is resolved.

By using these measures, boundary areas of the layer structure including the outer boundary area (surface) are able to be detected reliably, and analyzed accurately, if desired. In this context, the transitions (boundary areas or boundary layers), for example, may also be recorded in smaller regions of the layer structure while running through the scanning path, and measured more accurately if desired, since the correlation curves are uniquely determined.

It would also be basically conceivable to establish the presence of a plurality of boundary layers based on deformations in the superposed correlation curves; however, this procedure would be more prone to interference, and less accurate.

Greater lateral areas of the boundary areas may be measured relatively rapidly, and also with respect to one another, in that the receiver has a planar resolution in the x/y direction that is higher than the image of the local height changes of the layer surface in the x/y direction. Using these measures, one may also detect and evaluate relative changes of the course of the layers with respect to one another.

One advantageous embodiment for recording and evaluating is that in evaluation device AW, algorithms are programmed, using which, the boundary areas of the layer are able to be recorded separately from one another by having an allocation take place by the sequence of correlation curves occurring at the boundary areas, during a depth scanning cycle.

One possibility of basing the evaluation on pre-information on the layers is that there exists an input unit able to be operated by a user for inputting the number of boundary areas that is to be expected. Based on the number of boundary areas, the memory areas for the measured data concerning the boundary areas may then be established, for instance.

Another example embodiment for the evaluation is that the evaluation device has a coarse evaluation device, using which the number of layers or boundary areas present is able to be ascertained, based on a coarse recording of correlation curves, and the evaluation device is developed in such a way that the number of layers ascertained is automatically retrieved in an evaluation part or is able to be input by the user via the input unit.

If it is provided that the evaluation device has separate memory areas for the layers to be detected, to which data of the correlation curve associated with the respective boundary areas are separately able to be allocated during a depth scanning, the respective correlation curves being brought into relation with their depth scanning position, a great efficiency comes about, at relatively low expenditure, in the evaluation and the providing of measuring results.

The simple evaluation, in this context, is supported by the memory areas being developed as circulating memories.

A simple and rapid evaluation is also favored in that, for the recording of the correlation curves in connection with the boundary areas, a number of memory areas is present that exceeds the number of the boundary areas by at least one, of which one memory area is used as an active memory area for writing in current scanning data during the depth scanning, and the remaining ones are used for recording the ascertained correlation curve data associated with the respective boundary areas.

Contributions to a reliable recording of the correlation curves and the measuring of the boundary areas are furthermore made by the measures that the evaluation device has an evaluation area which is developed for computing the modulation of the intensity values obtained from the electrical signals during the depth scanning, and which is developed for recording of the correlation curves associated with the respective boundary areas, from the modulation.

One favorable design for more accurate measurements is for the evaluation device to have an evaluation module that may be used for carrying out a fine measurement of a respective boundary area.

In order to measure planar areas of the boundary areas, advantageous additional measures are that the evaluation device is developed in such a way that, during the depth scanning, the tracks running in the direction of the depth scanning are able to be simultaneously evaluated, in a corresponding manner, at various lateral boundary area regions that are adjacent directly or indirectly in the x-y direction.

In order to obtain more detailed insight, it may also be provided that the evaluation device is developed so that the boundary area data of the boundary area regions that are adjacent in the x-y direction are able to be brought into a relation with one another for a respective depth scanning and are able to be evaluated with respect to one another.

For a reliable evaluation and for accurate measurements, measures are furthermore of advantage in which, in response to the development of the interferometer part having a white light interferometer and a wavelength-scanning interferometer, the evaluation device is developed in such a way that, in a preliminary measurement, the entire layer structure is coarsely measured in a depth-scanning cycle to ascertain relevant regions, using the wavelength-scanning interferometer, and in a subsequent measurement, during a subsidiary depth-scanning cycle, a fine measurement of the relevant regions takes place using increased resolution.

A further example embodiment of the measuring device is that the evaluation device is developed to record striae in the layer structure from an evaluation of the interference contrast or the phase shift at the boundary areas brought about by the striae between media of different refractive indices, and further, that the evaluation device is developed for recording material changes or material transitions from an evaluation of the interference contrast or the phase shift at the boundary areas or boundary layers brought on by the material changes or material transitions which are created by the different refractive indices, for this recording, the interference contrast change or the change in the phase shift being incorporated into the evaluation laterally over the image field.

What also contributes to increased accuracy of the measuring results is that, in the development of the interferometer as a white light interferometer, a dispersion compensation is undertaken in that layers are inserted into the reference arm corresponding to the ones in the object arm.

In order to obtain reliable measuring results, measures are moreover of advantage that, in response to the development of the interferometer as a wavelength-scanning interferometer, in the evaluation device a software-supported dispersion compensation of the measured data is provided which is arranged in front of the actual measured data evaluation.

The evaluation is also favored by a variable optical attenuator being inserted in the reference arm, by which the light intensity is adjustable to the light intensity in the object arm in a controlled or regulated manner.

The data recording is favored by an optical system coupled to a regulating device being positioned in the object arm, which during the depth scanning has the effect of adjusting the focus to the area that is just being scanned.

An additional example embodiment for the reliable recording of the boundary areas is that the irradiation unit has optically pumped photonic crystal fibers and/or at least one superluminescence diode and/or at least one ASE light source.

### A BRIEF DESCRIPTION OF THE SEVERAL VIEWS OF THE DRAWING

FIG. 1 shows an interferometric measuring device for measuring layer structures, in a schematic representation.

FIG. 2 shows an intensity curve of an interference signal plotted against the scanning path in the depth direction (z) as a correlation curve and having the envelope, in a schematic representation.

FIG. 3 shows a white light interferometer in a representation in principle having a layer structure having a plurality of boundary areas and associated correlation curves.

FIG. 4 shows an intensity curve and a modulation curve obtained from it using an FSA algorithm, plotted against the scanning path in a representation in principle.

FIG. 5 shows various evaluation steps of an evaluation device in modular design.

FIG. 6 shows a representation in principle for measuring a layer structure having an oil film.

FIG. 7 shows a representation in principle for writing intensity values into a circulating memory area.

FIG. 8 shows an intensity curve and a modulation curve obtained from it plotted against the scanning path, having two identified correlation curves.

FIG. 9 shows an intensity curve and an associated modulation curve plotted against the scanning path having two correlation curves assigned to separate memory areas.

FIG. 10 shows an additional representation of an intensity curve and a modulation curve plotted against the scanning path having correlation curves written into two separate memory areas.

FIG. 11 shows an additional representation of an intensity curve and a modulation curve plotted against the scanning path having correlation curves assigned to two separate memory areas and increased scanning length.

FIG. 12 shows a representation of a modulation curve plotted against the scanning path having three associated correlation curves written into separate memory areas.

FIG. 13 shows a plurality of superluminescence diodes coupled via respective optical fibers for the bundling and coupling in of their spectra into a white light interferometer, in a schematic representation.

FIG. 14 shows an additional interferometric measuring device in combination with a tunable light source as wavelength-scanning interferometer and having a laser-pumped photonic crystal fiber as white light interferometer in a schematic representation.

### DETAILED DESCRIPTION OF THE INVENTION

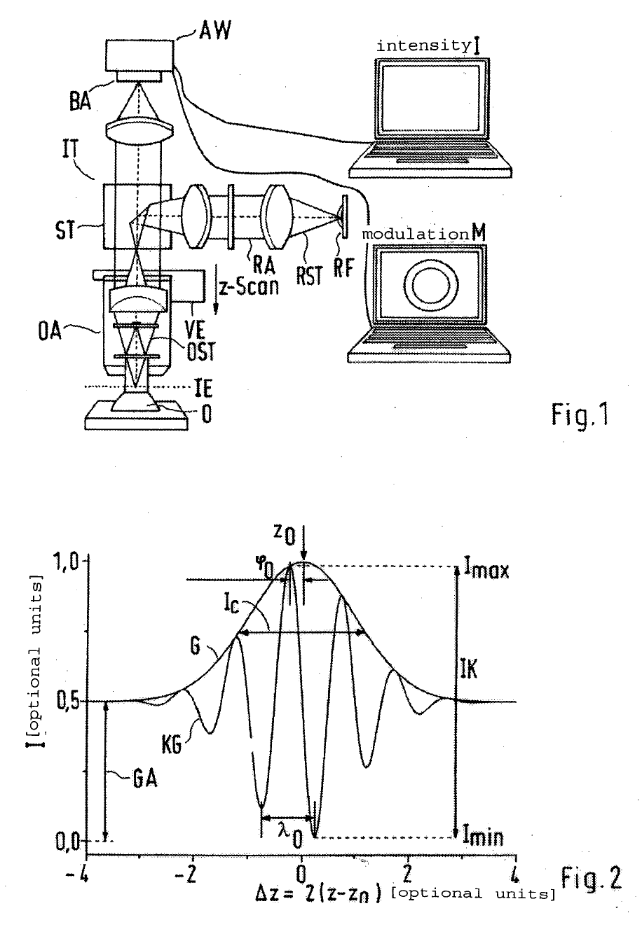

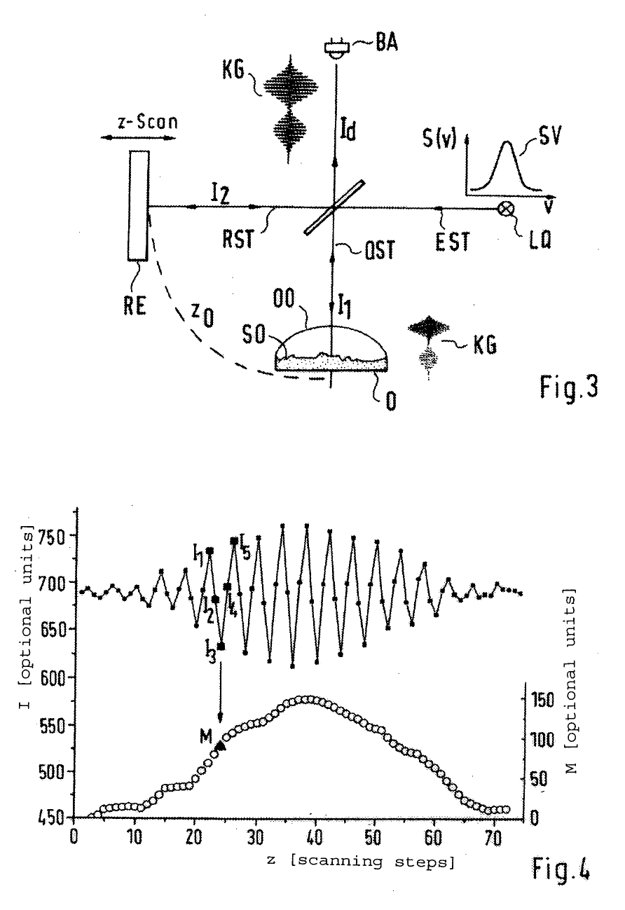

FIG. 1 shows an interferometric measuring device which is developed for measuring layer structures of a measured object O having a plurality of layers that are transparent to an object beam OST and that lie one behind another. An interferometer part IT has a beam splitter ST, by which an input radiation EST shown, for instance, in FIG. 3, is split up into an object beam OST that is guided through an object arm OA and into a reference beam RST that is guided through a reference arm RA, in order to generate an interference pattern that may be evaluated, as is known per se and as is described in greater detail, for instance, in the documents named at the outset, by superimposing reference beam RST, that is fed back at a reference surface RF, and object beam OST that is returned by the scanned layer structure of object O. With respect to object arm OA, interference plane IE is situated in the area of measuring object O or rather, of the layer structure. During the depth scanning of the layer structure in depth direction z, interference plane IE is displaced relative to the layer structure in the depth direction z, whereby different interference patterns occur over the track of the depth scanning. The depth scanning of the layer structure of interference plane IE may take place in various ways, namely, by changing the optical path length of the reference beam, particularly by moving the reference mirror, by moving measuring object O in the depth direction or by moving the objective in the depth direction or by moving the entire sensor relative to measuring object O. In the exemplary embodiment shown in FIG. 1, an adjustment of the objective in reference arm RA is made, using an adjusting unit VE, for instance, a piezoelectric adjusting unit, in discrete steps in depth direction z. To measure the layer structure, the interference pattern is recorded using an image recorder BA and converted to corresponding electrical signals, and is evaluated in a subsequent evaluation device AW, so as to obtain the measuring results that give information on the layer structures, especially the boundary areas. As image recorder BA, a camera is preferably provided which has side-by-side image recording elements pixel-wise in the x-y direction, and which resolves the imaged interference pattern area-wise, so that during depth scanning, a plurality of tracks of the layer structure assigned to the individual image elements are able to be recorded at the same time and evaluated.

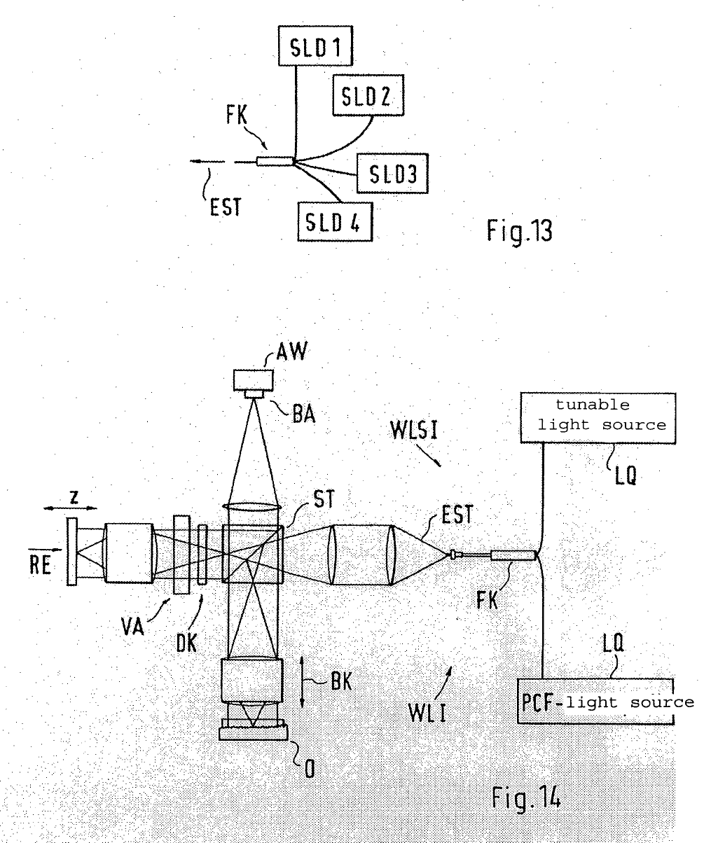

The measuring of the boundary areas may advantageously be carried out according to the principle of white light interferometry. For this, an irradiation unit or a light source LQ is used (cf. FIG. 3), which emits a short coherent radiation, for example, one or more superluminescence diodes SLD1 . . . SLD4 that are coupled together (cf. FIG. 13). In this connection, interference occurs only if the optical wavelength difference between reference beam RST and object beam OST is within coherence length l_{c} of the radiation emitted by irradiation unit LQ. The interference signal created is also designated as a correlogram in white light interferometry.

FIG. 2 shows a correlation curve KG which includes the intensity curve over the scanning path (in depth direction z), as well as the associated envelope G. As the characteristic parameters, the following are also entered: a direct component GA, the position of the optical path alignment z₀, the phase φ₀, a measure for the interference contrast IK as the difference between maximum intensity Iₘₐₓ and minimum intensity Iₘᵢₙ, central wavelength λ₀, intensity I in optional units and path difference Δ_{z} between the object arm and the reference arm as double difference of scanning position z and z₀ in optional units.

FIG. 3 shows the interferometric measuring device schematically, the scanning being undertaken, however, by displacing the reference surface, or rather, in the present case, reference plane RE. Object beam OST has intensity I, reference beam RST has intensity I₂, and at image recorder an intensity I_{d} comes about. The irradiation unit in the form of light source LQ emits an input radiation EST having a spectral curve SV of short coherence length. At the measuring object there are two boundary areas, namely, outer object surface OO and a substrate surface SO lying below it which, in response to scanning in depth direction z, yield correlation curves KG connected with this, which are included in intensity curve I_{d} to image recorder BA. For the exact recording and allocation of correlation curves KG to the respective boundary areas, an evaluation based on interference contrasts may be made. However, for the better recording, modulation M is ascertained in the present case, as is shown in FIG. 4 together with the associated intensity curve, plotted against scanning path z, and is also reproduced in FIG. 1 graphically on a visual display. In order to ascertain modulation M, in evaluation device AW a special algorithm is taken as a basis, namely the so-called FSA (five sample adaptive) algorithm, which is in turn based on the scanning of five successive intensity values of the interferogram, and from which the phase of the respective scanning position in the scanning path z may also be determined. With reference to the details of the FSA algorithm, we refer to the document of Larkin named at the outset.

One feature of the present interferometric measuring device and the measurement method is that scanning path z is selected to be at least so great that the entire range is scanned in which the boundary layers that are to be recorded are present, the correlation curves occurring at the various boundary areas during the scanning being recorded, in order to determine from this the presence of the boundary areas, using evaluation device AW. In this context, besides the coarse recording of the boundary areas, one may also undertake a fine recording of the height structures of the individual boundary areas. The area-wise recording, via the image-recording elements of image recorder BA or the camera K, simultaneously permits the recording of the height measuring data over several laterally adjacent tracks (in depth direction z), in this instance, so that 3D height data of the respective boundary areas may be acquired.

FIG. 5 schematically shows the procedure for ascertaining the boundary areas and, if desired, more detailed information on them. In evaluation unit AW the evaluation runs in several steps, for which, first of all, correlation curves KG in connection with the individual boundary areas are identified from the computation of modulation M of the intensity curves in a recording module EM. A more detailed evaluation is then made of the properties in an evaluation module AM of evaluation device AW, if desired. Finally, an assignment is made of the recorded boundary areas and possibly more detailed properties of same in an assignment module ZM, that is, for instance, of object surface OO and substrate surface SO.

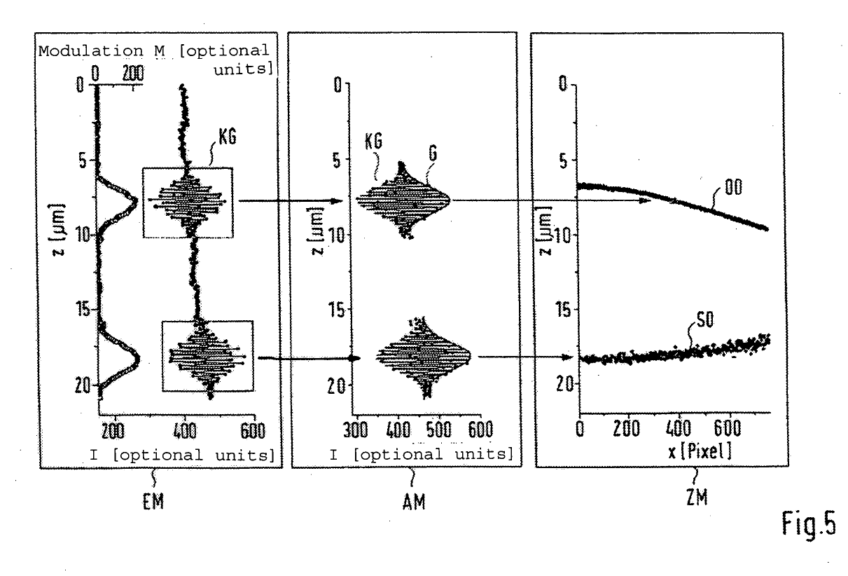

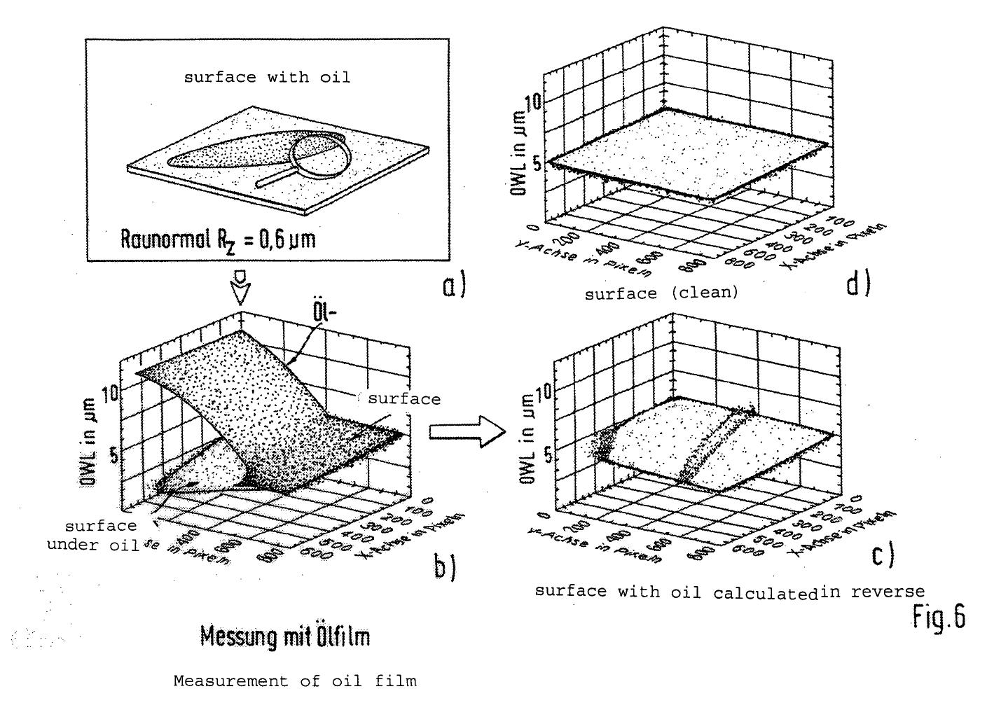

In FIG. 6 a layer structure, for example, is shown having a transparent layer in the form of an oil film on a carrier situated below it. By scanning the edge area of the oil film, one may, for example, establish the border of the oil film. the height curve may also be ascertained. Thus, for example, if one does not know ahead of time that there is soiling or deliberate coating of a substrate, the property of the layer may be detected based on the measuring result obtained.

Partial image a) shows the carrier provided with an oil layer, partial image b) shows a measuring result in the edge area of the oil film on the carrier surface, and partial image c) shows the surface of the carrier under the oil film that has been inversely calculated from the measuring result, while in partial image d) the clean surface of the carrier is shown.

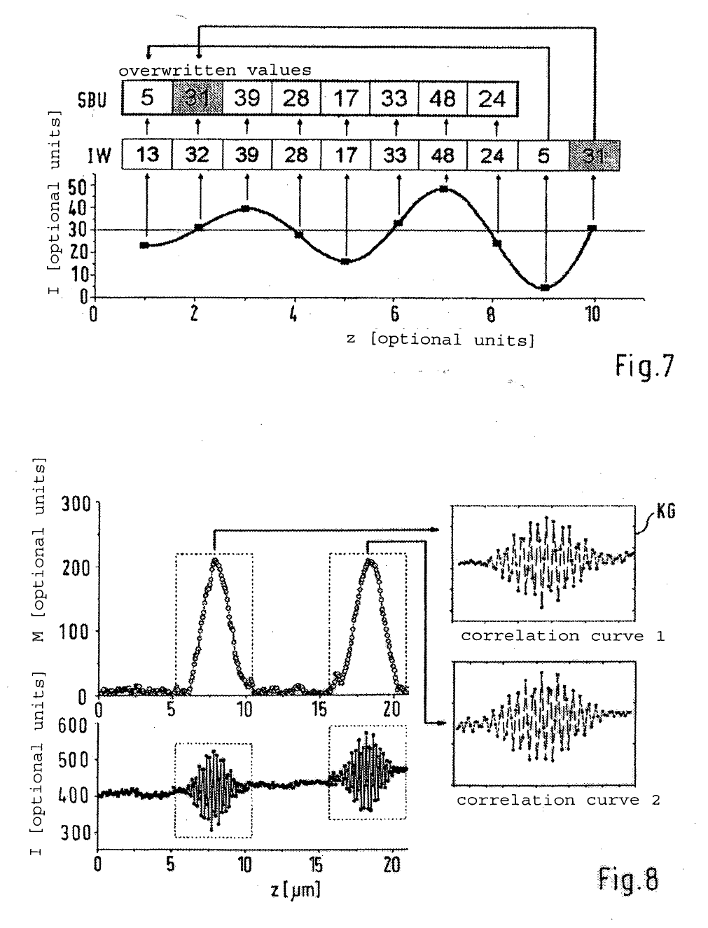

A further feature of the present measuring device and the measuring method is that, in evaluation device AW, the measuring data obtained during the depth scanning are stored in separate memory areas SB1, SB2 . . . , the recording of the individual boundary areas taking place and an assignment to the various boundary areas being made. This procedure is shown in FIGS. 7 through 12.

FIG. 7 shows the assignment of intensity values IW which are obtained during the depth scanning via one track, and their writing in a circulating memory area SBO of a certain length. During the writing process of intensity values IW, if the end of memory area SBU has been reached, the first word is overwritten again and at once. Consequently, for each image point x, y given by the image elements of image recorder BA, only an established number of intensity values IW scanned one after another is stored in the memory, and not the entire track. In FIG. 7, for instance, a circulating memory area is shown for eight intensity values IW. After the first eight values have been written in, the ninth value overwrites the value that is on the first memory address, and the tenth scanned value overwrites the second. By way of the depth scanning, in particular, characteristic places in the layer structure, that is, boundary areas between the layers or within the layers, such as material inclusions or the like, are supposed to be recorded. This area of interest should then be written into the memory area as completely as possible. With the aid of circulating memory area SBU it is then possible to record the areas of interest during depth scanning of the layer structure rapidly and reliably, there being only a small storage space requirement in comparison to the totality of the data coming in via the track. The length of circulating memory areas SBU is dimensioned, in this instance, according to coherence length l_{c}, and is selected to be greater by so much that an associated correlation curve is reliably recorded over a scanning length thus defined, as FIGS. 8 through 12 show, for example. The number of memory areas SB1, SB2, . . . is selected to be greater by 1 than the number of the boundary areas expected or ascertained in a pre-measurement. The circulating memory areas SBU are distinguished into different memory areas, namely one active memory area and passive memory areas, of which one forms a reserve memory area. Current intensity values IW are always written into the active memory areas. In response to the renaming of the memory areas, an algorithm decides to which memory address the active memory area is assigned at the moment. The active memory area is always that memory area which, of all memory areas SB1, SB2 . . . , includes the correlation curve having the lowest modulation maximum. If needed, that is, if the modulation maximum of the active memory area is exceeded during the depth scanning, the scanned measuring data are also written into the reserve memory area, in parallel with the active memory area. For this write process, the algorithm activates the reserve memory area. In the reserve memory area, that correlation curve is always stored which has the second smallest modulation maximum. The correlation curves having the strongest modulation are secured in the passive memory areas. The active memory area is renamed a passive memory area after the successful recording of a stronger-modulation correlation curve. Thus, if there is a new complete active correlation curve present in the active memory area, writing in it is stopped and writing continues only in the reserve memory area.

If an additional correlation curve follows having stronger modulation, it is recorded in the reserve memory area. If it is completely recorded, the other one is discarded. The two memory areas exchange functions, and the active memory area becomes the reserve memory area.

When a correlation curve has been completely recorded, the depth scanning position assigned to it is stored, and a resorting of the assignment of the memory areas according to maximum modulation takes place. The area named reserve memory area becomes the new active memory area, because at this point in time it includes the correlation curve having the weakest modulation. Of the remaining memory areas, the one having the next weakest maximum modulation is selected and set as the new reserve memory area. This method ensures that a correlation curve having weak modulation, which directly follows one having a stronger one, is also completely recorded still within the half scanning length, by simultaneous recording in the reserve memory area.

The number of memory areas, for example, is selected so that for N correlation curves that are to be recorded, N+1 memory areas assigned. If there are N=2 correlation curves to be recorded, there is a still further passive memory area besides the active memory area and the reserve memory area. The appropriate correlation curves, that is for N=2 only 1, having the largest modulation maxima, are stored in the passive memory areas. The correlation curve having the second largest (N) is stored in the reserve memory area, and correspondingly, the correlation curve having the third largest (N+1) modulation maximum is stored in the active memory area.

A counter ensures the current progress of the recording. The counter is initialized as starting value using one-half of the scanning length, and counted down to 0 per scanning step. It is started at maximum modulation and is reinitialized in response to a new maximum value, and started anew. It has the task of assuring that, after the modulation maximum has been reached, the remaining data are still written in the memory area. This ensures that there are sufficient values symmetrically located about the maximum of the envelope of the correlation curve in circulating memory area SBU and that the correlation curve is completely recorded.

When the total scanning path has been scanned, the recording process ends with a data transfer. For the subsequent precise evaluation, the correlation curves from the circulating memory areas are resorted in the correct sequence of the scanning points having the modulation maximum centrally in the memory area. The active memory area is canceled in response to this copying process.

In addition to intensity values IW of the correlation curves, the scanning position of the last scanning point is transferred to the next module.

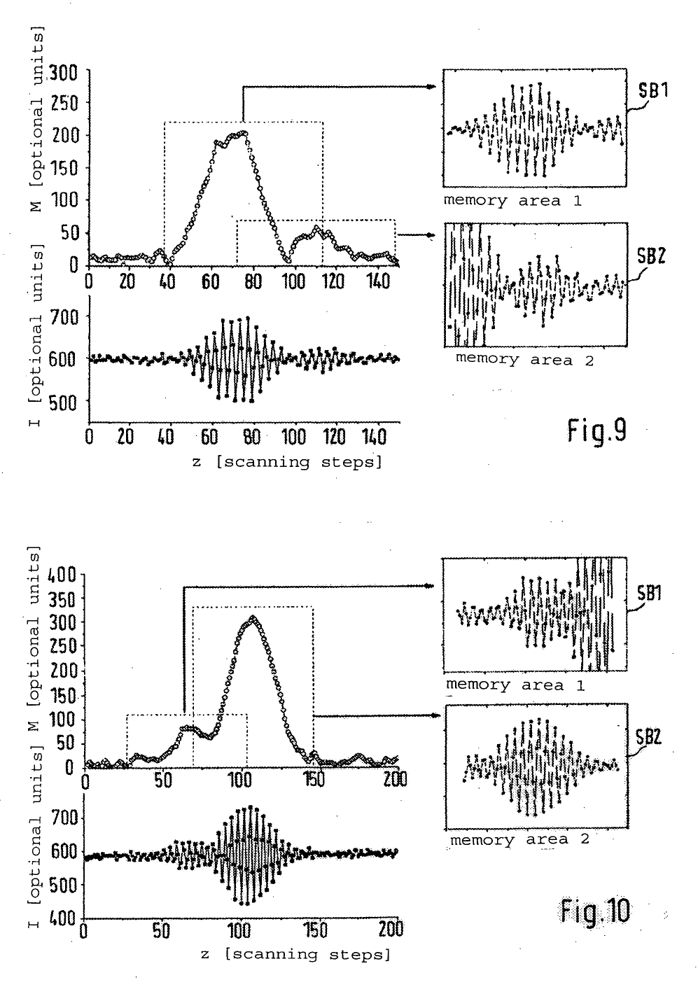

In FIG. 8 the intensity curve and the modulation curve are shown plotted against scanning path z having two identified correlation curves. FIG. 9 shows a memory state in the case of the recording of two correlation curves, a correlation curve having greater modulation occurring before a correlation curve having lesser modulation. FIG. 10 shows a memory state in the case of the recording of two correlation curves, a correlation curve having lesser modulation occurring before a correlation curve having greater modulation.

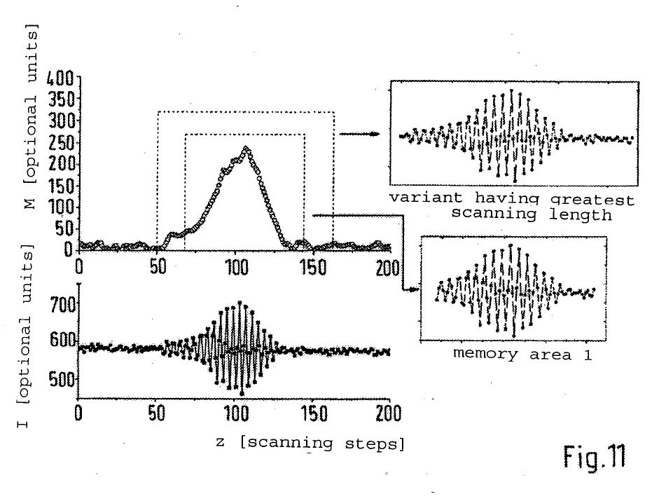

FIG. 11 shows an adjustment of the scanning length in the case of superposed correlation curves, as they occur on thin layers.

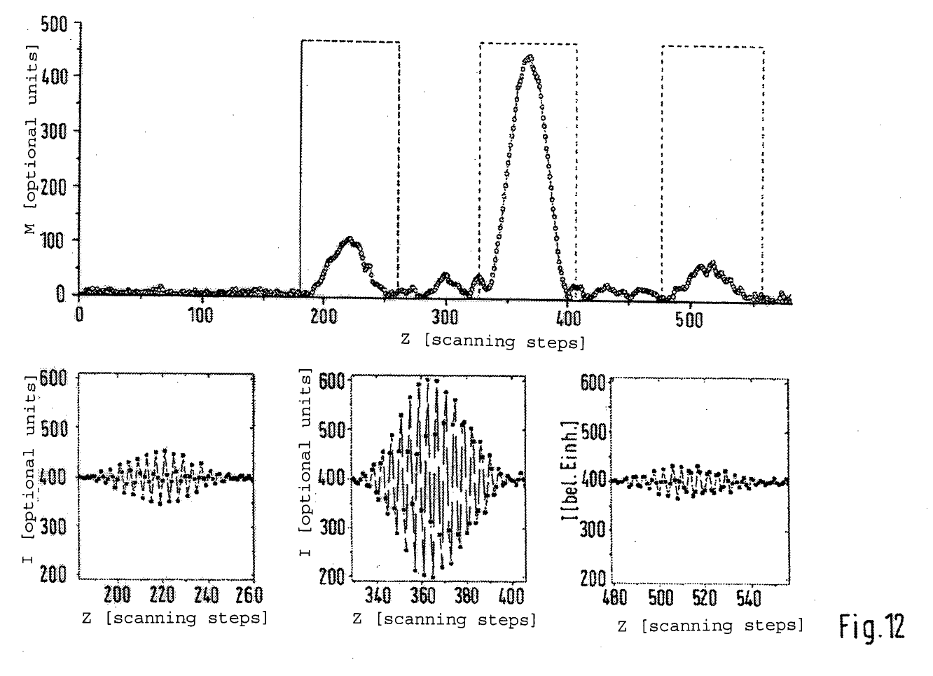

FIG. 12 shows a memory state in the case of the recording of three correlation curves.

In order to obtain a greater usable optical spectral range, and thus an improved height resolution and layer separation during the course of measuring an n-layered structure using the white light interferometer, many fiber-coupled superluminescence diodes LD1, LD2, LD3, LD4 . . . , or ASE light sources, having different overlapping optical spectra, may be advantageously recombined in the near infrared spectral range in a fiber coupler FK, in order to form an irradiation unit to introduce the input radiation into interferometer part IT, as shown in FIG. 13.

An additional interferometric measuring device for scanning a layer structure in the depth direction is that a wavelength-scanning interferometer WLSI is used instead of a white light interferometer. Within the meaning of the present invention, wavelength-scanning interferometers are characterized in that the optical spectrum of its spectral, narrow band, variably tunable light source or irradiation unit LQ is selected so that the layer structures to be investigated are partially transparent, or that the optical spectrum of the spectral, broadband irradiation unit is selected so that the layer structures to be investigated are partially transparent. Accordingly, the detector is adjusted to the light source LQ so that one may obtain as high a sensitivity as possible in the spectral range used. The selection of light source LQ and the detector or image recorder BA is therefore task-dependent, as is also true in the case of white light interferometer WLI described above. In the near infrared spectral range (approximately 1000 nm to 1800 nm) an InGaAs CCD camera is used as the image recorder, and in the case of the wavelength-scanning interferometer having a spectral narrow band, a variably tunable light source is used. For measurements in and through layers, during the wavelength-scan of light source LQ, the optical system in object arm OA of the wavelength-scanning interferometer is readjusted (e.g. by a computer-controlled piezo unit) in such a way that the area of the object that is just being scanned is always located in the focus of the optical system. This ensures a sharp imaging on image recorder BA or the detector.

An alternative embodiment of a wavelength-scanning interferometer WLSI is to design it to have a spectral broadband irradiation unit and a wavelength-scanning optical spectrum analyzer as detector. For the measurement, the bandwidth of the input radiation is selected to be so big that the smallest distance apart, of the boundary areas lying one behind the another that are to be recorded, that is to be expected or to be estimated by the pre-measurement, is resolvable.

Furthermore, it is advantageous, as is correspondingly true also for the interferometer part of the white light interferometer, if a variable optical attenuator is inserted in the reference arm, for instance, in the form of a liquid crystal element, in order to control light intensity I1 in reference arm RA and adjust it, via a closed control loop, to light intensity I2 in object arm OA, so that the contrast and the quality of the interferometer signal are increased.

By using application-specifically adapted reference surfaces/reference layers in interferometer part IT instead of a reference mirror or a reference plane RE, the quality of the measuring signal is increased, for instance, by the compensation for imaging errors or overexposure, and it is possible to measure specially formed objects, such as arched surfaces or structured layer systems. The corresponding applies also for interferometer part IT of the white light interferometer described above.

One exemplary embodiment for an interferometric measuring device is a combined measuring system made up of a white light interferometer WLI and a wavelength-scanning interferometer WLSI according to the embodiments described above. This combination is designed as a measuring system in that the irradiation units and light sources LQ are recombined via a fiber coupler FK (cf. FIG. 14), and the light is applied via a fiber into interferometer part IT, as shown in FIG. 14. The further elements of the interferometer part, such as variable attenuator VA and a dispersion compensation DK do not interfere with one another in such a combination and a joint utilization of interferometer part IT in, for instance, measurements that are arranged one after another in time. This makes it possible to combine the advantages of white light interferometer WLI and the wavelength-scanning interferometer. For thin layers or ones that are not highly dispersive or ones having experimental dispersion compensation, as a rule, a measurement using a wavelength-scanning interferometer WLSI is quicker, and a measurement using a white light interferometer WLI is more accurate. In the case of dispersive layers not having experimental dispersion compensation, the dispersion is able to be compensated for in wavelength-scanning interferometer WLSI, in a data postprocessing, so that, in that case, wavelength-scanning interferometer WLSI supplies the more accurate measured data.

In the development of the interferometric measuring device as a white light interferometer WLI, one should take care that the optical spectrum of its broadband light source LQ is selected in such a way that the layer structures to be investigated are partially transparent at least as far down as one lower nontransparent carrier substrate. Accordingly, image recorder BA, or detector, is adjusted to the irradiation unit or light source LQ so that one may obtain as high a sensitivity as possible in the spectral range used. The selection of light source LQ and of the detector is therefore task-dependent. In the case of area-wise measuring white light interferometers WLI as the detector, an InGaAs CCD camera is used in the near-infrared spectral range (ca. 1000 nm through 1800 nm). As light sources LQ in the near-infrared spectral range, so-called ASE (amplified spontaneous emission) light sources (e.g. laser-pumped Er fibers), laser-pumped photonic crystal fibers (PCF) or superluminescence diodes SLD are used. ASE light sources and superluminescence diodes are coupled into white light interferometer WLI via an optical free beam or by a light-conducting fiber. Photonic crystal fibers are directly connected to the interferometer part of white light interferometer WLI.

For the improvement of the height resolution and layer separation in measurements in and through layers, an experimental dispersion compensation is introduced. Dispersion effects in white light interferometer WLI are created by different optical paths in the object arm and the reference arm. During measurements through layers, in order to compensate for these effects, corresponding layers are also inserted in the beam path of reference arm RA of white light interferometer WLI. These layers are located at a distance from reference surface RF, for instance, in the form of a reference mirror, in order to avoid multiple correlation curves that superpose one another during the measurement. In the case of a white light interferometer WLI, for instance, such layers are inserted in the Linnik design between beam splitter ST and the microscope objective.

The use of pumped photonic crystal fibers, superluminescence diodes and fiber-coupled, bundled superluminescence diodes as well as the experimental dispersion compensation is not limited to the near-infrared spectral range.

The method carried out using the interferometric measuring device may be used both for relatively uniform, coherent layers, and for deformed layers having edges on a layer lying below it, such as oil layers, measurement of layer structures on substrates or under Si cap wafers, and also for measuring hidden structures within the layer structure. Thus, among others, it may also be used for measuring wear protection layers, lacquer layers and semiconductors, as long as the inclination of the respective surface or boundary area permits a sufficient retroflection of the incident light wave into image recorder BA.

In the recording of superposed double correlation curves on thin layers (e.g. <10 μm), algorithms are used in evaluation device AW which make possible, for instance, an adjustment of the scanning length (range within the total scanning path, especially of a correlation curve that is of interest). Alternatively or in addition, the number of correlation curves to be expected may be determined in a pre-scanning, and the number of memory areas may be appropriately adjusted.

As was stated above, within evaluation device AW, in addition to recording module EM and evaluation module AM, there is also an assignment module ZM and, if necessary, analysis modules, for a more accurate investigation. Assignment module ZM ensures the assignment of separation distance values to the corresponding boundary areas. In the case of an oil-substrate system, this assignment takes place according to the position of the correlation curves in response to the depth scanning. A comparison of the position takes place with, for instance, the eight nearest neighbors, for the assignment to the appropriate layers.

Using the interferometric measuring device, striae in layers may also be recorded, an interference contrast evaluation also being suitable. If a light beam is incident upon a boundary area between two media having different refractive indices n₁ and n₂, a part of the light beam is reflected to the boundary area. The magnitude of the reflected proportion is determined by the two refractive indices. For perpendicular incidence of light, the following applies:

I_{R}=I_{In}(n₂−n₁)/(n₂+n₁),

I_{R} being the reflected intensity and I_{In} being the intensity of the incident light beam. The intensity detected in a white light interferometer WLI is composed of the reflected intensities from reference arm RA and object arm OA. In the ideal case, the reflected intensity from reference arm RA is equal to the incident intensity I. The latter is superposed by reflected intensity I_{R} from object arm OA. The correlation curve shown in an image element (pixel) during the measurement of a boundary area using white light interferometer WLI has a maximum intensity value Iₘₐₓ=Iᵢₙ+I_{R} and a minimum intensity value Iₘᵢₙ=I_{In}−I_{R}. Taking into consideration interference contrast I_{Kon}, one obtains

I_{Kon}=(Iₘₐₓ−Iₘᵢₙ)/(Iₘₐₓ+Iₘᵢₙ)=I_{R}/I_{In}=(n₂−n₁)/(n₂+n₁)

which means that the interference contrast is determined by the two refractive indices n₁, n₂. By the evaluation of the interference contrast of the correlation curves of the white light interferometric measurement, in this manner, in one medium having a refractive index n₁, striae having a refractive index n₂ may be detected, and the type of the material inclusions may be classified by determining n₂ with the aid of the interference contrast. In the white light interferometric measurement, the position and the size of the striae are determined, at the same time.

Because of the different refractive indices at the boundary areas between the two media, the recording of the striae may also be performed based on phase observation, since the light beam experiences a phase shift Δφ at the boundary area which is determined by the properties of the two media. In the white light interferometric measurement, such a phase shift in object arm OA also has an effect on the phase of plotted correlation curve KG. This phase shift in the measuring signal is used in the phase evaluation in order to detect and classify striae having a refractive index n₂ in a medium having a refractive index n₁. At the same time, position and size of the striae may also be determined in this evaluation method.

Moreover, using the interferometric measuring device, material changes and material transitions of the layer structure are able to be recorded, for which an evaluation of the interference contrast or an evaluation based on a phase observation are suitable. As was described above, interferometer contrast I_{Kon} of the measuring signal obtained using white light interferometer WLI is a function of the two media, the ones that form the boundary area or the boundary layer that causes the signal. If the composition of the boundary layer changes over the image field of white light interferometer WLI, then the interference contrast changes as well. During the measurement of hidden layers, a change in the boundary layer composition is thus detected and measured via the interference contrast evaluation, for example, a transition between a printed circuit trace and the SiO₂ material underneath a Si cover layer.

In the phase observation for recording material changes and material transitions of the layer structure, it is utilized, in turn, that the phase shift of the measuring signal obtained using white light interferometer WLI is a function of the different refractive indices of the media, those that form the boundary area or the boundary layer causing the signal. If the composition of the boundary layer changes over the image field of white light interferometer WLI, then the phase position of the correlation curves changes as well. In the measuring of hidden layers it is thus also possible to detect and measure a change in the boundary layer composition via the phase change of the interference signal.

In wavelength-scanning interferometer WLSI, because of the wavelength-dependent refractive index curve, the dispersion comes about that has already been addressed. The dispersion effect deteriorates the measuring resolution of wavelength-scanning interferometer WLSI with respect to boundary layers that lie tightly under one another, since the separation of successive correlation curves is made more difficult. Because of the software-supported data preparation in the evaluation device, that has also been mentioned already, before the actual data evaluation in frequency space, the dispersion effect is compensated for if the refractive index curve is known, and the measuring resolution is increased in measurements in and through the layers of the layer structure.

The method also makes possible investigations of thick layers (d>>1.0 μm). In measurements in thick layers one first carries out a pre-measurement of the total layer thickness using wavelength-scanning interferometer WLSI having reduced resolution. This measurement clearly takes place more rapidly, based on the measurement principle of a wavelength-scanning interferometer WLSI, than a corresponding measurement using a white light interferometer WLI. The downstream measuring of the regions, identified by the pre-measurement as relevant, advantageously takes place using a white light interferometer WLI, for instance, having a photonic crystal fiber (PCF) light source, and, based on the measuring principle, it yields a better resolution with respect to height and layer separation.

The downstream measurement may also be made using a wavelength-scanning interferometer WLSI in a non-equidistant scanning. In this connection, the regions identified in the pre-measurement as relevant are scanned substantially more closely (for instance, by a denser frequency scanning) than regions lying in between that are not relevant. Because of the measuring principle, this too yields a better resolution with respect to height and layer separation.

The built-on accessories of the interferometric measuring device described above, and the methods carried out using them make possible a non-destructive, point-wise as well as area-wise measuring, in particular, of boundary areas in layer systems of various types that are optically partially transparent to radiation, striae and material changes as well as material transitions also being able to be detected and identified. The measuring method may be placed downstream from manufacturing and process control and/or quality control. Directly after the processing of a functional surface, it is then possible to check, for instance, the tolerances and to carry out a non-destructive process control and/or quality control on relevant product parts.

1-23. (canceled)

24. An interferometric measuring device configured for measuring layer structures of multiple layers positioned in a vertical stack arrangement relative to another in the depth direction, comprising:
a scanning apparatus configured to automatically scan the multiple layers in the depth direction, wherein displacing of an interference plane relative to the layer structure is enabled by the use of the scanning apparatus;
at least one of a white light interferometer and a wavelength scanning interferometer;
an irradiation unit configured to supply an input radiation to the at least one of the white light interferometer and the wavelength scanning interferometer for measuring layer structures;
a beam splitter configured to split the input radiation into a reference beam and an object beam, wherein the reference beam is supplied via a reference beam path to a reference arm, and wherein the object beam is supplied via an object beam path to an object arm, wherein the multiple layers are positioned in the object arm during the measuring of layer structure;
an image recorder configured to record an interfering radiation returning from the reference arm and the object arm, and convert the interfering radiation into electrical signals; and
a downstream evaluation device configured to provide results of measuring layer structures;
wherein the interferometric measuring device is configured to record a distance between at least two boundary areas of the layer structure that are recorded, and wherein a coherence length of the input radiation is selected to be no greater than a maximum value that enables interference maxima of correlation curves occurring one after another during the scanning in the depth direction to be distinguished at the at least two boundary areas of the layer structure that are recorded.

25. The measuring device as recited in claim 24, wherein in a three-dimensional coordinate system having mutually perpendicular axes X, Y and Z, the Z-axis corresponding to the depth direction, the receiver has a planar resolution in the X-Y direction that is greater than imaging of local height changes of the layer surface in the X-Y direction.

26. The measuring device as recited in claim 24, wherein the evaluation device is configured to record each individual layer separately during a depth scanning cycle by having an allocation take place by the sequence of the correlation curves occurring at the boundary areas.

27. The measuring device as recited in claim 26, further comprising:
an input unit configured to be operated by a user for inputting the number of boundary areas that are to be expected.

28. The measuring device as recited in claim 24, wherein the downstream evaluation device includes a coarse evaluation device, using which, based on a coarse recording of correlation curves, the number of layers or boundary areas present is ascertained, and wherein the downstream evaluation device is configured such that the number of layers or boundary areas ascertained is automatically retrieved in an evaluation part or is able to be input by the user via the input unit.

29. The measuring device as recited in claim 24, wherein the downstream evaluation device has a plurality of separate memory areas for detected layers, and wherein data of the correlation curve associated with the respective boundary areas are separately allocated to the separate memory areas during the depth scanning, the respective correlation curves being brought into relation with their depth scanning position.

30. The measuring device as recited in claim 29, wherein the separate memory areas are configured as circulating memory areas.

31. The measuring device as recited in claim 30, wherein, for the recording of the correlation curves in connection with the boundary areas, the number of separate memory areas exceeds the number of boundary areas by at least one, and wherein the at least one excess memory area is used as an active memory area for writing current scanning data during the depth scanning, and wherein the remaining separate memory areas are used to record the ascertained correlation curve data associated with the respective boundary areas.

32. The measuring device as recited in claim 29, wherein the downstream evaluation device has an evaluation portion configured to: a) compute the modulation of intensity values obtained from electrical signals during the depth scanning; and b) record the correlation curves associated with the respective boundary areas, from the modulation.

33. The measuring device as recited in claim 32, wherein the downstream evaluation device has an evaluation module configured to perform a fine measurement of a respective boundary area structure.

34. The measuring device as recited in claim 33, wherein the downstream evaluation device is configured such that, during the depth scanning, tracks extending in the direction of the depth scanning at a plurality of boundary area regions laterally adjacent in the x-y direction are able to be evaluated simultaneously.

35. The measuring device as recited in claim 34, wherein the downstream evaluation device is configured such that boundary area data of the boundary area regions adjacent in the x-y direction are brought into relation with one another and are evaluated with respect to one another.

36. The measuring device as recited in claim 29, wherein the downstream evaluation device is configured such that, in a pre-measurement, the entire layer structure is coarsely measured during a depth scanning cycle to ascertain relevant regions using the wavelength scanning interferometer, and in a subsequent measurement, in a downstream depth scanning cycle, a finer measurement of at least the relevant regions takes place at an increased resolution.

37. The measuring device as recited in claim 29, wherein the downstream evaluation device is configured to record striae in the layer structures based on an evaluation of one of the interference contrast or the phase shift developed at the boundary areas between media of different refractive indices.

38. The measuring device as recited in claim 37, wherein the downstream evaluation device is configured to record one of material changes or material transitions based on an evaluation of one of the interference contrast or the phase shift at the boundary areas brought on by the material changes or the material transitions which are created by the different refractive indices, and wherein for the recording of the one of the material changes or material transitions, one of a change of the interference contrast or a change in the phase shift is incorporated into the evaluation laterally over the image field.

39. The measuring device as recited in claim 29, wherein the white light interferometer is configured such that a dispersion compensation is undertaken in that layers are inserted into the reference arm corresponding to layers in the object arm.

40. The measuring device as recited in claim 29, wherein a variable optical attenuator is inserted in the reference arm, and wherein the variable optical attenuator adjusts a light intensity to the light intensity in the object arm.

41. The measuring device as recited in claim 29, wherein an optical system coupled to a regulating device is situated in the object arm, and wherein during the depth scanning the optical system coupled to the regulating device adjusts the focus to an area being scanned.

42. The measuring device as recited in claim 29, wherein the irradiation unit has at least one of optically pumped photonic crystal fibers, superluminescence diode, and ASE light source.

43. A method for interferometric measurement of layer structures of multiple layers positioned in a vertical stack arrangement relative to one another in the depth direction, comprising:
determining an interference plane by the optical path length of an object beam guided in an object beam path and by the optical path length of a reference beam guided in a reference beam path;
displacing the interference plane for depth scanning of the layer structures of the multiple layers in the depth direction of the layer structures;
generating an interference pattern using a white light interferometer;
recording the interference pattern using an image recorder;
evaluating the interference pattern using an evaluation device in order to generate measurement data concerning boundary areas of the layer structures;
wherein, in the depth scanning of the layer structures, in one scanning cycle, the object beam is guided over the same object beam path and the reference beam is guided over the same reference beam path, and the coherence length of the input radiation that is coupled into the interferometer is selected to be no greater than a maximum value that enables interference maxima of correlation curves occurring one after another during the depth scanning at boundary areas to be distinguished.

44. The method as recited in claim 43, further comprising:
assigning separate memory areas in the evaluation device to the detected boundary areas;
ascertaining, during the depth scanning, correlation curves associated with the boundary areas based on maximum modulation of the intensities yielded by the interference patterns; and
storing data of the correlation curves in the separate memory areas.

45. The method as recited in claim 43, wherein a dispersion compensation is carried out in the evaluation device before the evaluating of the interference pattern to generate the measurement data.
